(19) United States
(12) Patent Application Publication
(10) Pub. No.: US 2026/0284786 A1
(43) Pub. Date: Sep. 24, 2026

(54) DEVICE AND METHOD FOR LASER MACHINING

(71) Applicant: Schott AG, Mainz (DE)

(72) Inventors: Andreas Ortner, Mainz (DE); Fabian Wagner, Mainz (DE); Vanesser Glässer, Mainz (DE); Lukas Walter, Mainz (DE)

(73) Assignee: Schott AG, Mainz (DE)

(21) Appl. No.: 19/148,821

(22) PCT Filed: Jan. 16, 2024
(86) PCT No.: PCT/EP2024/050934

§ 371 Date: Jul. 17, 2025

(30) Foreign Application Priority Data
Jan. 17, 2023 (DE) 10 2023 100 969.9

(51) Int. Cl. B23K 26/08; B23K 26/0622; B23K 26/55; B23K 101/36; B23K 103/00

(52) U.S. Cl. CPC B23K 26/0823; B23K 26/0624; B23K 26/0869; B23K 26/55; B23K 2101/36; B23K 2103/54

(57) ABSTRACT

A device for laser machining workpieces includes at least one laser and a positioning apparatus, in order to set different impingement positions of a laser beam of the laser on a workpiece. The positioning apparatus includes a rotatable holder for the workpiece with a drive, in order to set the holder in rotation, and the rotational axis of the holder is oriented in such a way that it has a component parallel to the incidence direction of the laser beam, and the device includes a control apparatus that is configured, during the rotation of the holder, to control the emission of the laser beam in a synchronized manner with the rotation of the holder and in this way to set certain impingement positions of the laser beam on the workpiece. The laser is an ultra-short pulse laser which is suitable for adding filament-shaped degradations in workpieces made from glass.

### CROSS-REFERENCE TO RELATED APPLICATIONS

This application is a national stage entry under 35 U.S.C. § 371 of International Patent Application No. PCT/EP2024/050934 entitled “DEVICE AND METHOD FOR LASER MACHINING” and filed on Jan. 16, 2024, which is incorporated in its entirety herein by reference. International Patent Application No. PCT/EP2024/050934 claims priority to German Patent Application No. 10 2023 100 969.9 filed on Jan. 17, 2023, which is incorporated in its entirety herein by reference.

### BACKGROUND OF THE INVENTION

### 1. Technical Field of the Invention

The invention relates generally to material machining with a laser. In particular, the invention relates to the positioning of the workpiece to be machined in relation to the laser beam.

### 2. Description of the Related Art

In general, laser-based material machining methods are characterized by their high degree of flexibility in terms of the pattern the laser beam follows, as a result of the scanning of the laser beam across the workpiece. This also eliminates changeover times. Compared to other optical machining methods, such as traditional lithography in semiconductor manufacturing, however, there are disadvantages in machining speed, as the points on the workpiece to be machined are approached sequentially. Moreover, reversing the direction of movement is often necessary in this case, i.e. repeated deceleration, (brief) stopping, and acceleration in the opposite direction.

A speed-limiting parameter, for example, in the filamentation of transparent materials is the laser frequency. If the product is positioned under the laser at the right time, the laser frequency determines how many filaments can be inserted into the product per unit of time. Commercial lasers can enable frequencies of up to 2 MHz. Higher frequencies are also becoming technically feasible.

To maximize the laser frequency, the workpiece would have to be moved at a correspondingly high speed. X-Y tables are typically used for this. The machining pattern is traversed, for example, column by column (e.g. Y-section). Within a column travel, the table is accelerated in order to be able to achieve corresponding process speeds, and this speed must be slowed down again at the end of the column. This results in the following disadvantages:

Acceleration and braking sections can be used inside or outside the workpiece. Outside the workpiece, the times of the acceleration and braking sections cannot be used for processing. This increases the process time. Furthermore, each column must be approached separately, which requires additional process time.

Sudden deceleration and acceleration, in combination with mass, lead to vibrations, thus resulting in a loss of accuracy and increased wear on the system. To reduce vibration after deceleration, waiting periods are necessary before restarting; the system controls provide correspondingly configurable waiting times and positions. These acceleration and deceleration sections of the table lead to greater deviations in linear alignment. This problem occurs in particular in the case of large products (200 mm wafers or larger) with a very high density (e.g. 1 structure per 5 mm²).

High pulse frequencies can also lead to incomplete material machining. For example, at very high frequencies (2 MHz), some lasers may no longer be able to properly produce filaments when inserting them into transparent materials. At such high frequencies, the energy is often insufficient to develop the entire filament. The structuring in the workpiece will then no longer be homogeneous.

### SUMMARY OF THE INVENTION

The invention is therefore based on the object of accelerating the machining of workpieces with lasers and also improving the positioning accuracy of the point of impact of the laser on the workpiece.

Accordingly, the device provides a device for laser machining workpieces, wherein the device comprises at least one laser and a positioning apparatus for setting or approaching or scanning various impact positions of a laser beam of the laser on a workpiece. The positioning apparatus has a rotatable holder with a drive for rotating the holder. The axis of rotation of the holder is oriented such that it has a component parallel to the direction of irradiation of the laser beam, or to the axis of the laser beam. The device comprises a control apparatus which is configured to adjust the emission of the laser beam during the rotation of the holder and in this manner adjust the impact position of the laser beam on the workpiece. The adjustment of the impact positions can be performed in particular through the points in time of the emission of the laser beam and/or the angular position of the holder.

A corresponding method for laser machining workpieces can be performed with the device, in the case of which
a workpiece is machined with a laser beam emitted by a laser, wherein the workpiece and the laser, or more generally the laser beam, rotate relative to one another in order to approach or adjust different impact positions of the laser beam of the laser on a workpiece, wherein
the laser beam is directed onto the workpiece in such a way that the direction of irradiation of the laser beam has a component parallel to the axis of rotation of the holder, and wherein
controlled by a control apparatus during the rotation of the holder, the emission of the laser beam is adjusted as a function of the angular position of the holder and thus the impact position of the laser beam on the workpiece.

It is preferred if the workpiece is rotated, i.e. if the holder represents a holder for the tool. This configuration is easier to implement in many cases and requires a lower rotating mass. Accordingly, in a preferred further development of the method
a workpiece is held on a rotatable holder of a positioning apparatus,
the holder is set in rotation by means of a drive, and
the workpiece rotating on the holder is machined with a laser beam.

The angular position of the holder can encompass by the angle of rotation or, correspondingly, the time elapsed since a specified starting point in time. In other words, the control apparatus is configured to control the emission of light in synchronization with the rotation of the holder in order to achieve a specific position of the point of impact of the laser light on the workpiece.

A core idea is thus a rotating product table, or rather, a rotating holder during laser machining. The axis of rotation of the holder can be set to a fixed angular speed. This eliminates acceleration and braking sections and waiting times at the holder for vibrations to dissipate.

Particularly preferably, the positioning apparatus also comprises an adjustment apparatus for adjusting the impact positions of the laser beam in the radial direction relative to the axis of rotation of the holder. For this purpose, for example, a laser head can be positioned on a linear axis above the product table or the holder. The length of the linear axis can then be selected such that the laser head can always move at a constant speed on a part of the axis. Acceleration and braking sections are outside this section. The section with constant laser head speed can then correspond to half the length of the product diagonal (in the case of square products) or the radius in the case of round products.

If the laser head moves continuously over the rotary table during processing, according to a further development of this embodiment, rotation and linear movement can be advantageously coordinated. In this way, for example, the distance between the machining points along the paths can then be kept constant.

In general, by rotating the workpiece and radially adjusting the impact positions of the laser beam, the entire workpiece can be scanned and structured accordingly. Instead of scanning in a Cartesian coordinate system, as is in principle done with an XY table, the positioning of the impact points according to this disclosure is based on a polar coordinate system.

It is particularly advantageously possible for the rotating table to operate at rotational speeds of 5 to 25 revolutions per second, in particular 7 to 20 revolutions per second. This allows for particularly efficient machining of the workpieces, i.e. a very large number of filament-shaped defects can be introduced within a time interval.

The workpiece provided by the device and/or method described herein can be used particularly advantageously for electronic components, in particular as an interposer, in which the filament-shaped defects are preferably configured as through-contacting through the glass, in particular by further developing the filament-shaped defects as through-openings, which are advantageously filled with metal or wherein at least the side walls of the through-opening are metallized. In this way, an electrical contact can be established between different surfaces of the otherwise electrically insulating workpiece.

### BRIEF DESCRIPTION OF THE DRAWINGS

The device and method according to this disclosure, as well as further embodiments, are described below with reference to the figures. In the figures, identical reference numerals refer in each case to identical or corresponding elements.

FIG. 1 shows schematically a device for laser machining.

FIG. 2 shows a device for laser processing with several workpieces in plan view.

FIG. 3 shows a variant of the example shown in FIG. 2 with a swivel arm for radial positioning of the laser.

FIG. 4 and FIG. 5 show variants with a plurality of lasers.

FIG. 6 shows an arrangement for machining transparent workpieces.

FIG. 7 and FIG. 8 show two different configurations for machining a workpiece.

FIG. 9 shows a machined glass workpiece with filament-shaped defects.

FIG. 10 shows a further development of the device with an apparatus for rotating the workpieces on the holder.

FIG. 11 shows a holder in cross section with details of the holding mechanism.

FIG. 12 shows a diagram of the radial coordinate of the point of impact as a function of the angle of rotation.

FIG. 13 shows an arrangement in which the laser is rotated relative to the workpiece.

### DETAILED DESCRIPTION OF THE INVENTION

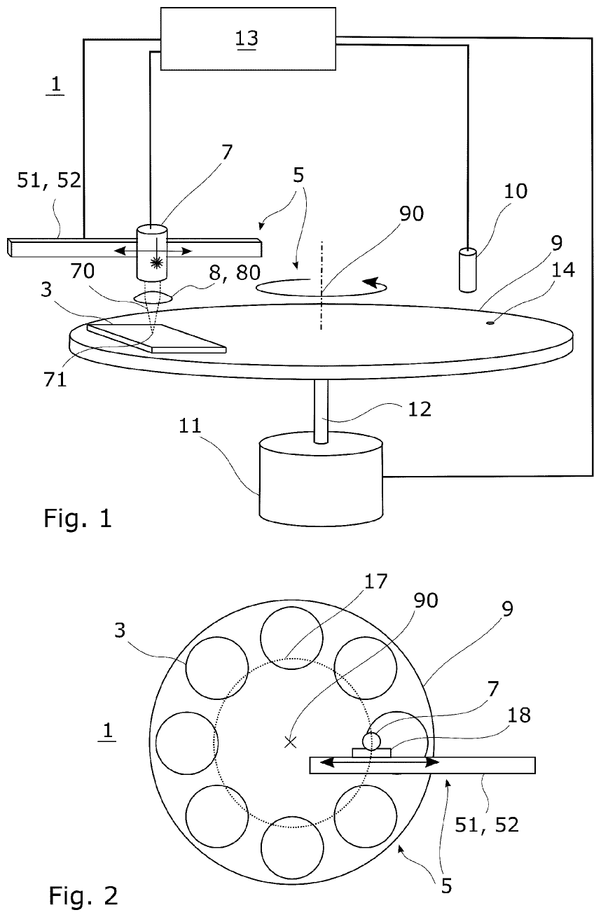

The device 1 shown in FIG. 1 for laser machining of workpieces 3 comprises at least one laser 7 and a positioning apparatus 5. The positioning apparatus 5 generally serves to position specific positions to be machined on the workpiece 3 relative to the laser 7 in order to align the impact position 71 of the laser beam with the position to be machined on the workpiece 3. In order to adjust the various impact positions 71 of a laser beam 70 of the laser 7 on the workpiece 3, the positioning apparatus 5 comprises a rotatable holder 9 for one or more workpieces 3. The holder 9 is set into rotation with a drive 11. For example, the holder 9 can be connected to the drive 11 via a shaft 12. As can be seen from the illustration, the axis of rotation 90 of the holder 9 is preferably generally oriented such that it has a component parallel to the irradiation direction of the laser beam 70. Without restriction to the example represented, it is particularly preferred that the laser beam 70 is irradiated parallel to the axis of rotation 90. However, irradiation oblique to the axis of rotation 90 is also conceivable. This can be realized, for example, by the laser optics being designed to be rotatable and being able to co-rotate mechanically or optically (for example, with an SLM) depending on the rotational position of the substrate. To achieve a high light intensity on or in the workpiece 3, the laser light is preferably focused by means of focusing optics 8. In the simplest case, this focusing optics 8 can comprise a lens 80. If filament-shaped defects are to be introduced into the workpiece using the device 1, such defects can be achieved through self-focusing in the material. In particular, however, it is also possible to design the focusing optics 8 to generate an elongated focus. For this purpose, the focusing optics 8, according to a first embodiment, can have a lens 80 with a sufficiently high spherical aberration, so that the focus is elongated by caustic distortion. Another alternative or additional possibility is the use of an axicon as a component of the focusing optics. The axicon is a conical prism that generates an approximately thread-like focus.

The device 1 furthermore comprises a control apparatus 13, which is configured to adjust the emission of the laser beam 70 during the rotation of the holder 9 as a function of the angular position of the holder 9 and thus the impact position 71 of the laser beam 70 on the workpiece 3. Furthermore, the drive 11, as represented in the example, can also be actuated by the control apparatus 13, for example, to control the rotational speed. In order for the control apparatus 13 to detect the angular position of the holder and thus the angular coordinate, one or more trigger markings 14 on the holder 9 can be detected, for example, by a sensor 10.

The positioning apparatus 5 generally comprises, without restriction to the specific example represented, particularly preferably an adjustment apparatus 51 for varying and thus adjusting the impact positions 71 of the laser beam in the radial direction relative to the axis of rotation 90 of the holder 9. According to a preferred configuration, a positioning arm 52 is provided for this purpose as a component of the positioning apparatus 51, with which the laser beam 7, in particular the laser 7 or a beam guidance optic of the laser 7, can be moved in the radial direction. For example, for this purpose, the laser 7 can be attached to a carriage 18 that can be moved along the positioning arm 52. For the movement in the radial direction, for example, linear drives with a positioning accuracy of 1 μm or better are used.

According to one embodiment, which also forms the basis of the represented example, the laser 7 is mounted on the positioning arm 52 in a linearly movable manner. The longitudinal direction of the positioning arm 52 runs in the radial direction, in particular as represented. However, it is not mandatory that the adjustment of the impact position takes place in a precisely radial direction. A movement oblique to the radial direction also allows the variation of the impact position in the radial direction on the workpiece 3, as long as a component of the movement in the radial direction is present.

Only circular paths or paths which are also to be covered with structures by the laser beam can be used by means of the adjustment apparatus 51, in order to shorten the machining time.

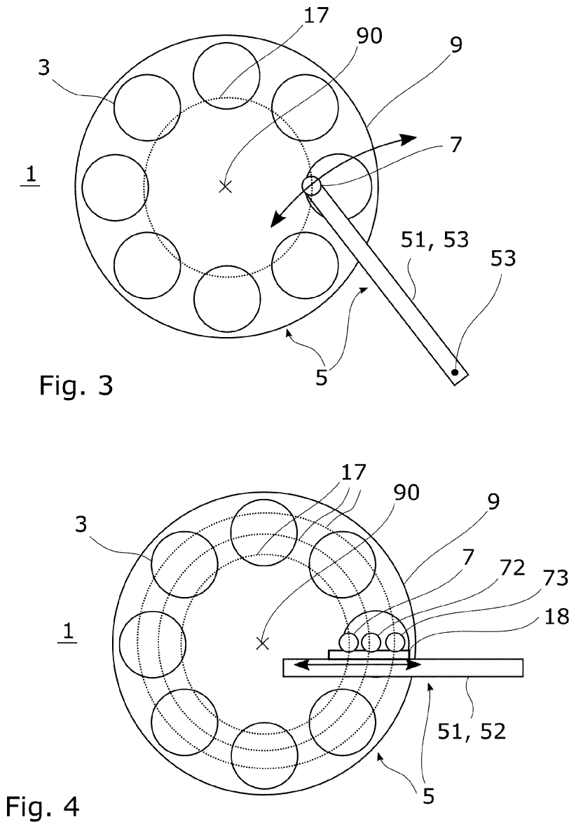

FIG. 2 shows in this regard a device 1 for laser machining with multiple workpieces 3 on the rotatable holder 9. As mentioned, the example in FIG. 3 is based on an embodiment of the device 1 in which the rotatable holder 9 is configured to hold multiple workpieces 3 such that a curved, in particular circular, path 17 sweeps over the multiple workpieces 3 at a constant radial distance from the axis of rotation 90, so that during one rotation of the holder 9, the multiple workpieces 3 can be machined with the laser beam 70 at impact positions 71 along this path 17 while maintaining a fixed radial position of the laser beam 70. The path 17, which the laser beam sweeps at the current position of the laser 7, is shown in the figure as a circular dashed line.

The paths 17 can be exactly circular. However, it is also possible and advantageous if the laser beam 70 is moved in a spiral path 17 relative to the workpiece 3. For this purpose, one embodiment provides that the laser 7 or the laser beam 70 is continuously moved with a movement component in the radial direction, at least temporarily during the rotation of the holder 9, and the workpiece is machined during this movement by irradiation of the laser beam 70.

In the case of the example shown in FIG. 2, the laser is also moved in a precisely radial direction by means of a positioning arm 52 in order to be able to adjust the various impact positions in the radial direction. As already mentioned, however, a different movement can also occur, as long as it has a radial component. For example, in a further embodiment, the holder 9, including its drive 11 and shaft 12, is mounted on a substructure located underneath it that can be displaced linearly in the radial direction, and the laser head maintains its position during processing. Thus, according to a further embodiment, the adjustment apparatus 51 comprises a pivot arm to which the laser 7 is pivotably attached relative to the holder 9. For this purpose, it is expedient if the pivot axis of the pivot arm lies parallel to the axis of rotation 90 of the holder 9. An example of such an embodiment with a positioning arm in the form of a pivot arm 53 with pivot axis 54 is shown in FIG. 3. Such an embodiment can be particularly advantageous if vibrations caused by a linear drive along a positioning arm 52 are also to be avoided in order to achieve the greatest possible positioning accuracy.

The device 1 generally also offers the possibility of machining workpieces simultaneously with multiple lasers. According to one embodiment, the lasers can be arranged such that they machine the workpiece on different circular, concentric paths 17. One such example is shown in FIG. 4. In the case of this example, the lasers 7, 72, 73 are arranged on a common carriage 18 and coupled thereto. For example, a variant is also possible in which multiple carriages 18 with one or more lasers are guided on a common positioning arm 52 and can thus be adjusted independently of one another in their radial position.

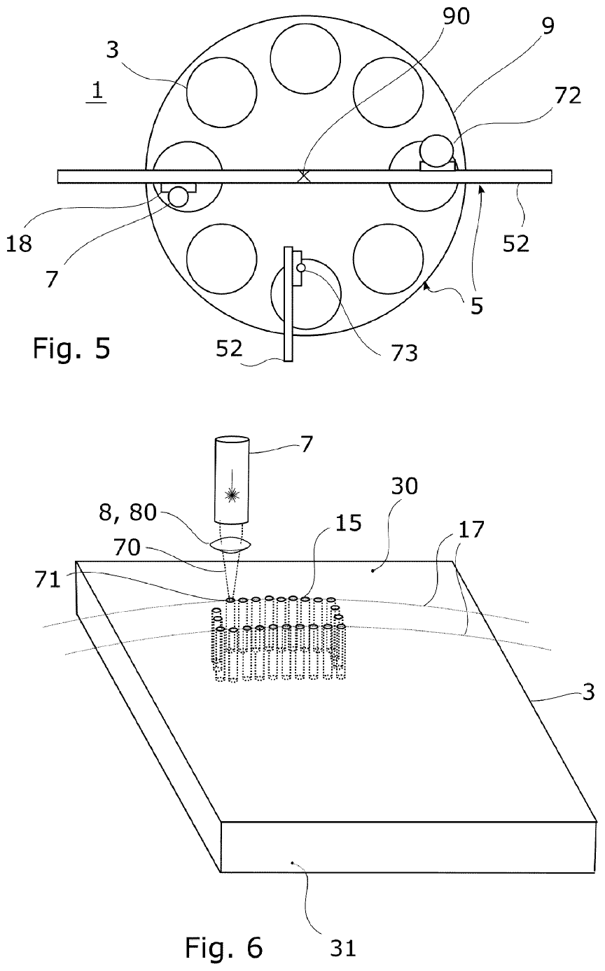

FIG. 5 shows a variant in which several lasers 7, 72, 73 are attached to several positioning arms 52. One positioning arm 52 is designed as a crossbeam on which two lasers 7, 72 are guided. The lasers can be arranged opposite one another with respect to the axis of rotation 90, as represented, so that the lasers 7, 72 can simultaneously machine two workpieces 3 at opposite positions on the holder 9. A third laser 73 is guided to a separate positioning arm 52 in this example. As indicated by the different sizes of the lasers 7, 72, 73, the lasers can be different and can also perform different machining processes on the workpieces 3. This naturally applies not only to the example of FIG. 6, but generally to embodiments of a device 1 in which several lasers are provided for machining the workpiece(s).

The following table compares the parameters and process times achieved during laser processing by means of a device 1 according to this disclosure, as well as by means of an XY table for positioning as a comparative example. The device 1 according to this disclosure is referred to as a rotary table in the table.

| | Example no. and evaluation | | | | | | | |
|---|---|---|---|---|---|---|---|---|
| | Example 1: | | Example 2: | | Example 3: | | Example 4: | |
| | Comparable | | Rotary table | | XY table better in case | | Rotary table better in case | |
| | speeds | | better | | of design with few columns | | of design with many columns | |
| Device type | Rotary table | XY table | Rotary table | XY table | Rotary table | XY table | Rotary table | XY table |
| Number of columns | | 1800 | | 1800 | | 600 | | 3000 |
| (reference design) | | | | | | | | |
| Workpiece size in [mm] | 500 | 500 | 500 | 500 | 500 | 500 | 500 | 500 |
| Radius/length x-axis in [mm] | 353.6 | | 353.6 | | 353.6 | | 353.6 | |
| Center structure-free | 0 | | 0 | | 0 | | 0 | |
| region radius in [mm] | | | | | | | | |
| Maximum path circumference/ | 2221.4 | 500.0 | 2221.4 | 500.0 | 2221.4 | 500.0 | 2221.4 | 500 |
| section [mm] | | | | | | | | |
| revolutions [1/s] | 12 | | 20 | | 20 | | 12 | |
| Acceleration [mm/s²] | 5000 | 5000 | 5000 | 5000 | 5000 | 5000 | 5000 | 5000 |
| Waiting time until | 0.5 | 0.5 | 0.5 | 0.5 | 0.5 | 0.5 | 0.5 | 0.5 |
| vibration dissipation [s] | | | | | | | | |
| Maximum (path) speed [mm/s] | 26657 | 500 | 44429 | 500 | 44429 | 500 | 26657 | 500 |
| Required accuracy in [μm] | 5 | 5 | 5 | 5 | 5 | 5 | 5 | 5 |
| Required laser frequency | 5331.5 | 100.0 | 8885.8 | 100.0 | 8885.8 | 100.0 | 5331.5 | 100 |
| in [kHz] | | | | | | | | |
| Number of laser heads | 1 | 1 | 1 | 1 | 1 | 1 | 1 | 1 |
| Total number of revolutions | 35355.3 | | 35355.3 | | 35355.3 | | 35355.3 | |
| Process time laser in [s] | 2946.3 | 1800 | 1767.8 | 1800 | 1767.8 | 600 | 2946.3 | 3000 |
| Process time approach in [s] | 5 | 900 | 5 | 900 | 5 | 300 | 5 | 1500 |
| Process time acceleration in [s] | 10.7 | 360 | 17.8 | 360 | 17.8 | 120 | 10.7 | 600 |
| Total process time in [min] | 49.4 | 51 | 29.8 | 51 | 29.8 | 17 | 49.4 | 85 |

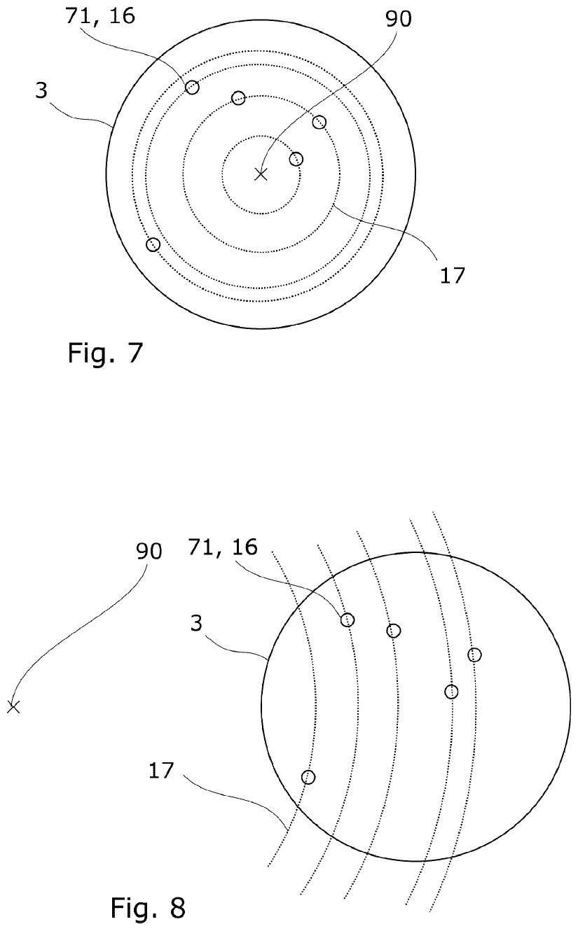

For the exemplary embodiments listed in the table, lines running next to one another of machining points were inserted into the workpieces measuring 500 mm×500 mm within a portion of 410 mm in length as a reference design using the laser and the XY table arrangement. In examples 1 and 2, this was 1800 lines, in example 3600 lines, and in example 4, 3000 lines. These reference designs were then reproduced using the rotary table, so that the two workpieces of one example each have approximately the same number of machining points, or in this case, filament-shaped defects. The workpiece was machined with the rotary table in such a way that the machining lines run in a radial direction when machined with the rotary table, so that that path 17 crosses the machining lines in each case and the machining points are inserted one after the other on adjacent machining lines. The laser was movable above the rotary table by means of the positioning apparatus in the radial direction from the position of the axis of rotation over a distance of 353.6 mm, allowing machining up to the center of the workpiece, so that no central structure-free area is required. Since the workpiece was held according to the arrangement from FIG. 7, the entire workpiece can be machined, even though the radial displacement path is less than the aforementioned 410 mm. This represents a general advantage of an arrangement in which the axis of rotation is located in the region of the workpiece, in particular centrally in relation to the workpiece. As can be seen from the examples, machining with a device according to this disclosure, with otherwise comparable parameters, is faster than machining with the XY table, especially with a large number of columns. In contrast, the XY table can be faster with a small number of machining points, as can be seen from example 3. With a large number of machining points, the rotary table has an advantage, among other things, since acceleration and braking processes can be eliminated. In particular, high tangential speeds can be achieved even with small workpieces without losing time for acceleration and deceleration.

This speed advantage increases considerably when several workpieces 3 are machined simultaneously, as in the examples in FIG. 2 to FIG. 5. The machining time does not change in this case, whereas the machining time on an XY table scales with the number of workpieces.

Depending on the laser and the workpiece material, the device can be used to perform various laser machining methods. A particularly preferred machining process comprises the introduction of filament-shaped defects into transparent workpieces, in particular into glass. For this purpose, a laser 7 is generally provided, which is an ultrashort pulse laser and preferably has pulse lengths of less than 100 ps, preferably less than 20 ps, less than 10 ps, preferably less than 3 ps, less than 1 ps, particularly preferably less than 0.5 ps, and which preferably emits these pulses with a repetition frequency between 50 kHz and several megahertz, preferably 100 kHz, 200 kHz, 400 kHz, 800 kHz or more than 1 MHz or more than 2 Megahertz, which emits its pulses as individual pulses or pulse groups, whose emission wavelength lies in a range in which the workpiece is transparent, for example, a laser whose wavelength lies in the range between 300 nm and 1500 nm, particularly preferably an emission wavelength in the range between 500 nm and 1100 nm, the pulse energies of which are preferably more than 1 μJ, preferably more than 10 μJ, preferably more than 50 μJ, particularly preferably more than 100 μJ, or even more than 200 μJ, and which is suitable, as represented in FIG. 6, for introducing filament-shaped defects 15 into workpieces 3 made of glass. Of the device 1, only the laser 7 and the focusing optics 8 with a lens 80 are represented in FIG. 6. The workpiece 3 is, as shown again, moved past by the rotation of the holder along a curved, in particular circular, path 17, so that the impact positions 71 of the pulses of the laser beam 70 lie on the respective path 17.

The workpiece 3, preferably a glass workpiece, is transparent to the laser light. However, the intensity of the laser beam 70 is so high due to the pulsed light emission and the focusing that nonlinear interactions occur in the glass and damage is caused in the volume of the workpiece 3. The typical range of nonlinear interaction of dielectric materials, in particular glasses, lies in the intensity range of at least 10¹² W/cm², preferably greater than 10¹³ W/cm², in the region of the focal line, but can also exceed values greater than 10¹⁶ W/cm². This damage is preferably elongated or filament-shaped and extends following the irradiation direction of the laser light in the direction from a main surface or side surface 30 to an opposite main surface or side surface 31. The damage can in particular be located entirely within the substrate or can also penetrate one of the side surfaces 30, 31 or even both side surfaces 30, 31, has an elliptical or circular cross-section and extends laterally over a length of less than 3 μm, preferably less than 2 μm, preferably less than 1 μm, particularly preferably less than 0.7 μm or less than 0.5 μm or 0.35 μm or even less than 0.1 μm. Depending on the length of the focal line, the modification produced also varies in length and extends over a length of at least 1 μm, more than 3 μm, 5 μm, more than 10 μm, more than 50 μm, more than 100 μm, more than 500 μm, more than 1000 μm, or even more than 2000 μm, 3000 μm, 5000 μm or even more than 10000 μm or 20000 μm. The laser is preferably operated in bursts of 1 to 10 laser pulses and a burst frequency greater than 1 MHz, preferably greater than 10 MHz, particularly preferably greater than 20 MHz, very preferably greater than 40 MHz, and in particular preferably greater than 100 MHz. The pulse duration is preferably less than 20 ps, preferably less than 10 ps, particularly preferably less than 1 ps and very particularly preferably less than 0.5 ps.

An elongated shape of the damage 15 can be created, in particular, by focusing the laser beam 70 through the focusing optics 8 to an elongated focus in the volume of the workpiece 3. Suitable optical elements for this purpose include, for example, lens elements with (high) spherical aberration or the use of an axicon, which each map parts of the incident laser beam onto different positions on the optical axis depending on their distance from the optical axis on the output side of the element, thus creating an elongated focus. In a further embodiment, an SLM (Spatial Light Modulator) element is used, which changes the phase of the incoming laser radiation and can thus even create elongated, curved focal areas (e.g. airy beam focus). The filament-shaped defects 15 can, in particular, have the shape of channels, but in other embodiments can also be realized as modifications of the substrate material, in particular in the form of refractive index modifications, modifications of the redox state (local coloring), local crystallization, or cracks in the substrate material. These can even extend completely through the workpiece, creating a connection between the opposing side surfaces 30, 31. The filament-shaped defects thus introduced can then form the basis for various further structuring machining processes of the workpieces. According to a further development of the method, it can be provided that the workpiece 3 is subjected to an etching process so that the filament-shaped damage is widened by the etching medium. This allows the creation of individual holes and, by combining neighboring, expanding filament-shaped defects, even larger structures such as cavities, openings, or trenches. With a series of defects inserted next to each other, a predetermined fractured point can also be inserted, at which the workpiece can be separated.

In general, the laser(s) can be formed for at least one of the following machining operations or can carry out the following machining operations:
a local decoating, or local removal of a coating on the workpiece 3,
filamentation, or the above-described insertion of filament-shaped defects 15 into the workpiece 3,
local heating, in particular for melting or generating thermal stresses,
ablation on the surface of the workpiece, for example, for chamfering previously produced channels,
modification of the material of the workpiece, such as in particular a local change in the refractive index, the redox state, a local coloring or discoloration or local crystallization.

The generation of thermal stresses can be used, for example, to separate the workpiece 3 after introducing filament-shaped defects 15 at these defects 15, for example, if the defects 15 are introduced along a designated separation line. The CO₂ laser, the CO or also Erb:YAG laser are particularly suitable for this purpose.

According to an alternative or additional embodiment, various machining methods can generally be performed sequentially or intermittently using a laser. Thus, different features or feature sizes can be produced by appropriately varying the pulse energy or duration (varying between femtosecond, picosecond, or nanosecond pulses), thus enabling a change in machining methods. For example, an arrangement of filament-shaped defects 15 could be introduced in one machining step, and then, by changing the laser parameters in the area of the defects, local heating could be achieved to separate the workpiece by generating thermomechanical stresses.

In the case of the example shown in FIG. 6, an approximately rectangular contour is formed from adjacent filament-shaped defects 15. The radially spaced sides of the contour are inserted by a rapid sequence of laser pulses or bursts, so that their spacing results from the path speed and the burst or pulse frequency of the laser. Due to the circularly curved paths 17 resulting from the rotation of the holder 9, these sides of the contour are also correspondingly slightly curved in this example. If necessary, this curvature can be neglected, or the filament-shaped defects can be inserted segmentally in several revolutions to compensate for any curvature. FIG. 7 and FIG. 8 show two different configurations for machining a workpiece 3, preferably a workpiece in the form of a wafer, in particular a glass wafer.

The machining points 16, corresponding to the impact positions 71 of the laser beam 70 on the workpiece 3, for example, in the form of a glass wafer, are the same in both cases. For both configurations according to FIG. 7 and FIG. 8, the machining effort and thus also the machining speed are comparable. While with the central position of the axis of rotation 90 in the center of the workpiece, four revolutions are required to cover all points to be machined, with the eccentric position of the axis of rotation 90 according to FIG. 8, an additional pass is necessary. However, this is only due to the fact that in the case of the position of the machining points, two of these points in FIG. 7 lie incidentally on a common circular path 17. The number of passes therefore depends on the pattern of the machining points 16 and their positioning relative to the point of rotation. In principle, it still applies that machining a single wafer with the axis of rotation 90 in the center takes a similar amount of time as processing a single wafer outside the center. However, machining a workpiece 3 with an axis of rotation outside the center takes exactly as long as machining several workpieces that are held outside the axis of rotation 90 and have the same distance from the axis of rotation 90.

Particularly high processing speeds can therefore be achieved if, as also represented in FIG. 2 to FIG. 5, the holder 9 is formed to hold the workpiece 3 eccentrically outside the axis of rotation 90. The center of rotation through which the axis of rotation 90 runs is therefore located outside the workpiece 3 to be machined. In this way, a correspondingly higher tangential speed is achieved, with which the workpiece 3 moves relative to the laser 7. This higher speed is, of course, particularly relevant for the machining speed when several workpieces 3 are placed on the holder 9 in such a way that they can be scanned by the laser beam 70 during one rotation of the holder.

Conventional lasers often have a lower process frequency than the maximum nominal frequency of the laser. This process frequency enables the production of a homogeneous and reproducible filament. To make optimal use of this frequency, the rotational speed of the holder can be selected such that the local path speed below the laser head corresponds to a product of an accuracy parameter and the pulse frequency. Generally, with increasing radial distance, an increasing tangential speed results. With a constant processing frequency of the laser, for example, its pulse frequency, this would lead to a greater distance between the machining points 16. To compensate for this, the control apparatus 13 can generally be configured to adjust at least one of the parameters pulse frequency of the laser 7 and rotational speed of the holder 9 depending on the radial distance of the impact point 71 of the laser beam 71 from the axis of rotation 90. In a further embodiment, the control of the axis of rotation is configured in such a way that with increasing radial position of the laser machining head, the rotational speed (angular speed) is reduced in such a way that the distance between the machining points on the respective path remains constant at least in portions or even overall.

An advantage in the machining speed and accuracy compared to the holder on an XY table results from the movement mechanism with a rotation of the workpiece 3 relative to the laser 7, especially when a large number of machining points 16, or impact positions 71, are provided along the circular or more generally curved paths 17. Workpieces 3, which have been machined with the device 1 and the method according to this disclosure, are therefore preferably characterized by at least one, preferably several, of the following features:
a high density or a high total number of machining points 16,
a large surface area of the workpiece 3,
a small accuracy fluctuation in the xy position of the machining points 16.

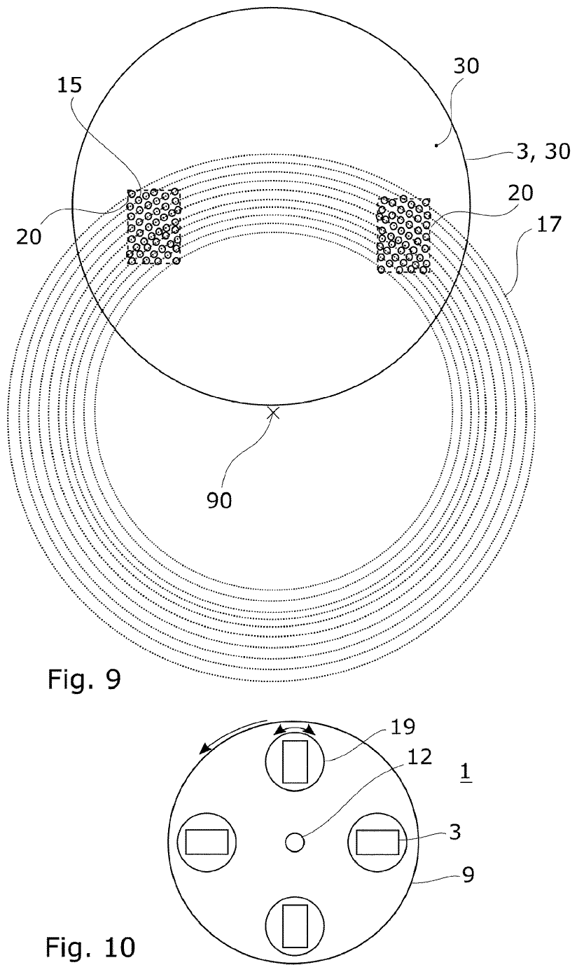

A typical feature of a machined workpiece 3 is, in particular, that the machining points 16 are arranged closely one behind the other on curved paths 17, wherein the paths 17 are arranged concentrically, or due to this, wherein the paths 17 have a radius of curvature that increases in a direction along the machined surface of the workpiece 3. This direction corresponds to the radial direction on the holder 9. As mentioned above, the method is particularly preferably used for introducing filament-shaped defects into glass. According to a further aspect of this disclosure, a workpiece 3 made of glass with two opposite side surfaces 30, 31 is therefore correspondingly provided, which has a plurality of filament-shaped defects 15 which run transversely, preferably perpendicularly to the side surfaces 30, 31 in the volume of the workpiece 3, wherein the filament-shaped defects 15 are arranged in a row on a plurality of curved paths 17, the radius of curvature of which increases in a direction along a side surface 30, 31, such that the paths 17 run concentrically. Two such paths 17 with filaments 15 arranged in a row can already be seen in the example of FIG. 6. FIG. 9 shows in this regard a machined, plate-shaped workpiece 3 made of glass with filament-shaped defects 15. The defects 15 are arranged, for example, in two machined portions 20. Within these portions 20, a plurality of filament-shaped defects 15 are distributed, which are arranged along several closely spaced, concentric circular paths 17. Preferably, the distance between at least two adjacent curved paths 17, in particular within a machined portion 20 of the workpiece 3, is at most five times, preferably at most twice, the distance between the filament-shaped defects 15 along the paths 17. Generally speaking, the curved paths 17 can therefore have a small distance in the radial direction compared to the distance between the filaments along the path 17. It is then also advantageous to provide an adjustment apparatus 5 which provides a correspondingly high adjustment resolution in the radial direction. According to one embodiment, the adjustment apparatus 5 has in this regard an adjustment accuracy of better than five times, preferably better than twice the distance of the filament-shaped defects, according to an alternative or additional embodiment, an adjustment accuracy of 5 μm or better.

As can be seen from the illustration, the machining according to this disclosure results in a characteristic pattern of the arrangement of the filament-shaped defects 15 by the arrangement in a row of the defects 15 along curved concentric paths, which can be easily identified on the workpiece 3. The example of FIG. 9 is only schematic with regard to the quantity of filament-shaped defects 15. For the purpose of clarity, only two machined portions 20 are shown here. In order to be able to exploit the high machining speed, it is advisable to introduce significantly more of these defects into the workpiece 3. Thus, according to an alternative or additional embodiment, it is generally provided that at least 10, preferably at least 20, in particular at least 50, better at least 100, preferably at least 500 filament-shaped defects 15 per square centimeter are introduced into the workpiece 3, averaged over the surface area of a side surface 30 or 31. In a further alternative embodiment, the machined substrate has one or more regions with the above-mentioned manufacturing densities in a preferably rectangular, square shape or alternatively in the form of a 2D free-form surface.

In order to provide a high resolution and/or adjustment resolution, it can be provided that the rotatable holder is provided with means and/or that means are assigned to the rotatable holder that make the angle of rotation of the rotatable holder measurable. For example, these can be markings on the rotatable holder that are arranged at defined distances on the rotatable holder, for example, a rotating table, and that are readable and/or detectable, advantageously by means of optical scanning. These markings are generally referred to as increments in the context of this description. For example, several increments can be applied as line markings per degree at a suitable location on the rotatable holder. By continuously counting the increments, in particular, the position of the rotatable holder, i.e. in particular the angle of rotation, can be determined at any time.

One exemplary embodiment provides for the processing of workpieces, in particular glass substrates. A spatial accuracy of at least 5 μm is advantageous. In this sense, spatial accuracy means that a filament-shaped defect introduced into the workpiece deviates from the intended location of the defect by a maximum of 5 μm. Such workpieces can be used, for example, as substrates for electronic applications, in particular as interposers.

To achieve this, a spatial resolution of 0.5 μm is desired. To process a single substrate with an edge length of, for example, 500 mm in the rotational structure according to the invention, a rotational radius of 500 mm×2^{0.5}=353.6 mm is required, which corresponds to a circumferential distance of 353.6 mm×π=2.221 m. To achieve a spatial resolution of 0.5 mm along this circumference, the rotational axis should provide approximately 4.4×10⁶ increments during one revolution, or approximately 12340 increments per degree.

However, if—as represented, for example, in FIGS. 5-8 or even 10 substrates of this size are to be machined on the rotating holder for economic reasons, the length of the outer path of the rotating holder increases to approximately 10 m and thus the number of minimum required increments increases accordingly.

It is particularly advantageously provided within the meaning of the invention that the positioning accuracy interacts with the control of the laser, in this case the ultrashort pulse laser. A high pulse or repetition frequency of the ultrashort pulse laser source is desired. For example, to be able to structure with the desired accuracy at a path speed of 44 m/s, a pulse frequency of 8.88 MHz is required. At a maximum path speed of 100 m/s, the required pulse frequency increases by a factor of 2.27 to 20.2 MHz.

However, for the desired structuring result, such as a through-hole created directly by the filament-shaped damage or through subsequent machining, a certain minimum energy per laser pulse is required. Based on an advantageous single pulse energy of 400 μJ and a pulse frequency, also referred to as repetition frequency, of 20 MHz, a desired maximum average laser power is 8 kW; similarly, with a single pulse energy of 1000 μJ, an average laser power is 20 kW. In general, the device and/or method according to the invention therefore advantageously provide(s) pulse frequencies of 6 MHz to 30 MHz, in particular of 8 MHz to 25 MHz or of 8 MHz to 22 MHz.

A further advantageous configuration provides that the required laser power can be reduced by using so-called pulse pickers. The ultrashort pulse laser source comprises, in particular, a seed laser and an amplifier unit. During pulse picking, only certain, in particular selectable pulses of a seed laser are selected and fed to the amplifier unit. For example, it is possible to set the pulse picker to select only every second, every fifth, or even every tenth pulse or fewer from the seed laser and forward them for amplification. In particular, it is also possible to select pulses from the seed laser on request and have them amplified. In this way, stable individual pulse energies can be provided in a particularly advantageous manner, i.e. sequences of individual pulses whose energies differ little from one another.

Furthermore, it is advantageously provided to allow the movement of the laser and the rotation to interact. In the case of the examples of FIGS. 4, 7 and 9, several discrete circular paths 17 are represented, along which the laser 7 sweeps over the workpiece 3. However, it is furthermore particularly advantageous if the laser beam 70 is continuously moved with a movement component in the radial direction, at least temporarily during the rotation of the holder 9, and the workpiece 3 is machined during this movement by irradiating the laser beam 7. In this case, a curved, still essentially circular, but in particular spiral-shaped path 17 results. In this way, acceleration and braking processes are also eliminated when switching between discrete paths 17 of different radii.

It is particularly advantageously provided to process workpieces using burst pulses. In this case, the laser emits a packet of laser pulses following one another in very short succession, the so-called burst packet. The individual pulses of the burst packet create the filament-shaped damage. With increasing path speed and/or longer burst duration, the introduced damage becomes increasingly elliptical because the substrate has already moved further during this time. Typical damage diameters, i.e. the diameter of the filament-shaped damage, in the case of individual processing are between 100 nm and 2000 nm, preferably between 200 nm and 1000 nm and/or are particularly advantageously less than 500 nm. For later application, it should be noted that even with an etching process following the laser processing, the introduced shape is essentially retained, i.e. circular or elliptical defects are enlarged by the etching process in a shape-preserving manner. Therefore, if approximately round defects are to be created by applying burst pulses, a lateral offset Δx_{Burst} of a total of half the diameter of the damage is often desired between the first and last burst pulse. In general, with a burst pulse count of n_{Burst} and a shift of Δx_{Burst} between two consecutive burst pulse, the following applies

$${n}_{Burst} \cdot Δ {x}_{Burst} \leq s \cdot {ϕ}_{S}$$

In this case, φₛ is the diameter of the filament-shaped damage. Ranges for s are advantageous between 0 and 1. s is particularly advantageous less than or equal to ½ for circular diameters of the filament-shaped defects. Defects with s<1 can still be considered sufficiently circular, while those with s>1 are considered elliptical. For example, if “mere” through-contacting for electronic components on printed circuit boards is to be created, burst pulse-generated defects with s>1 are acceptable. It should be noted that the lateral offset Δx_{Burst} between two consecutive individual pulses in the burst packet is a function of the burst frequency of the laser source and the path speed of the substrate, and thus also depends on the angular velocity of the substrate and the radial distance of the machining point from the center of rotation.

For the purpose of illustration, this section considers a comparative example of a linearly movable apparatus. Typical values in the case of such a device are: laser repetition frequency fᵣₑₚ=100 kHz, laser burst frequency f_{Burst}=50 MHz, and speed vₗᵢₙ of the rotatable holder of 500 mm/s. The lateral displacement x_{Burst} of the damage center points between two burst pulses is then x_{Burst}=vₗᵢₙ/f_{Burst}=10 nm. The distance between two defects, also called pitch, measured at the damage center points, is calculated analogously according to x_{Pitch}=vₗᵢₙ/fᵣₑₚ=5 μm.

The device and/or method according to the invention enable higher path speeds. In one exemplary embodiment according to the invention, values for the path speed are 45 m/s (see table). Typically, with components available at the time of the invention, path speeds between 2 m/s and 100 m/s can be achieved. In the case of this path speed v_{Path} of 100 m/s and a burst pulse frequency f_{Burst} of 50 MHz, a displacement x_{Burst} between two burst pulses results according to x_{Burst}=v_{Path}/f_{Burst} of up to 2 μm. As previously described, with the selection of suitable process and laser parameters, the damage dimensions along the path of movement can be elliptical and significantly larger than typical damage diameters in a single-shot process (i.e. without a burst).

It is particularly advantageously possible to introduce the filament-shaped defects with a preferred direction. In particular when introducing contours or cutouts, it can be advantageous for the introduced damage chain (i.e. the sequence of filament-shaped defects) to not only run linearly in one direction, but also to be able to change direction. For filamentation processes that essentially produce circular defects, it is sometimes advantageous for the subsequent processes, e.g. mechanical or thermal separation, chemical etching, etc., if the direct distance between adjacent defects, the so-called pitch, is sufficiently small, for example, less than 10 μm or less than 5 μm, so that the created contour runs as precisely as possible along the damage chain and, for example, a running crack caused by mechanical stresses does not rip into the surrounding workpiece material.

It is particularly advantageously possible to introduce filament-shaped defects with shapes that deviate from the circular shape, in particular asymmetric shapes and/or shapes that widen in the direction of the intended separating line, which, when aligned in a controlled manner, define a preferred direction for the subsequent separating process. The particular advantage here is that, due to the preferred direction, the pitch between adjacent defects can be significantly increased, and thus fewer defects are required overall to be able to separate the workpiece. To create an internal cutout (e.g. circular, elliptical, rectangular with rounded corners (cf. FIG. 6) and/or free-form contour), it may therefore be necessary to rotate the preferred direction during processing. This can be achieved by designing each workpiece holder itself to be (automatically) rotatable or by rotating the optics, at least the optical subsystem that generates the preferred direction, i.e. the asymmetry in the spatial energy distribution of the laser, in particular by rotating it automatically. Particularly advantageous for this purpose are mechanically rotatable components as well as purely electronic beam-influencing components such as e.g. a spatial light module (SLM), which can change the beam contour within microseconds or less. This advantageously ensures that the preferred direction and the intended separating line lie on top of one another during processing.

In general, portions 20, as shown in the example of FIG. 9, can be machined very effectively with the device as represented by way of example in FIGS. 1 to 5, since in each case many machining points are inserted one after the other along the swept paths 17. However, the machining becomes less effective if the impact points 71 are distributed in one or more narrow lines in the radial direction, i.e. lines that lie transversely to the curved paths 17. In order to insert such a pattern of machining points into the workpiece 3, an apparatus for rotating the workpiece 3 with respect to the holder 9 can be provided in a further development of the device 1. FIG. 10 shows such a further development of the device with an apparatus 19 for rotating the workpieces 3 on the holder 9. By rotating the workpieces 3 with respect to the holder 9, the orientation of the workpieces with respect to the curved paths 17 can be adjusted. In this way, structures can first be created which have a high number of machining points 16 arranged in a row in one direction, the workpiece 3 is then rotated on the holder 9 and then structures can be created which have a high density of machining points in the path now swept by the laser beam.

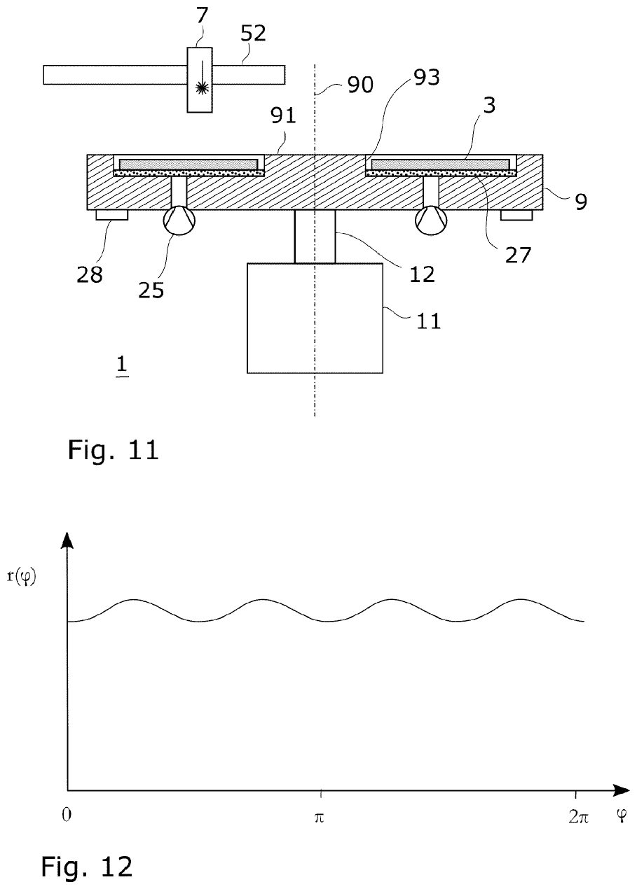

The device and method according to this disclosure are particularly suitable for machining plate- or disk-shaped workpieces 3, in particular glass panes 30. Preferred glasses are borosilicate glasses, aluminosilicate glasses, such as the glasses sold by Schott AG under the names D263 or AS87, AS87 eco, alkali-free glasses, such as the glass sold by Schott AG under the name AF32, and soda-lime glass, such as the glass B270 from Schott AG. Other, in particular also brittle-hard, workpiece materials that can be processed as workpieces using the device described here are glass ceramics, sapphire, and semiconductors, such as silicon. With workpieces made of brittle-hard materials and high rotational speeds of the holder, there is a risk that the workpiece will fracture during processing. To prevent fracture and possible fragments from damaging the device, several measures can be used, which are explained on the basis of the example of FIG. 11. FIG. 11 shows in this regard the device 1 with the holder 9 in cross-section. In general, without restriction to the specific example represented, the workpiece 3 can be held flat, preferably by means of vacuum, i.e. by suction of the workpiece against the support surface of the holder 9. A further alternative or additional measure is to hold the workpiece 3 countersunk relative to a surface 91 of the holder 9 facing the laser beam 70. For this purpose, a recess 93 can be provided, as represented, in which the workpiece 3 is received. The recess 93 is formed such that the workpiece 3 does not protrude beyond the surface 93.

As a further, alternative or additional measure, a flat holding by means of vacuum is possible, as already mentioned. The workpiece 3 is sucked onto the holder 9 and thus fixed. For example, a porous support 27 can be provided for this purpose, onto which the workpiece 3 can be placed. In combination with a recess 93, this support 27 can then form the bottom or part of the bottom of the recess 93, as also shown by way of example in FIG. 11. The porous support is connected to a vacuum apparatus in order to suck the workpiece 3 onto the support 93. One problem here is providing the vacuum on the rotating holder 9. According to a further development of this embodiment, one or more vacuum pumps 25 are provided, which are arranged on the holder 9 and therefore rotate with it. This embodiment is independent of the other features of the specific example of FIG. 11. For example, the porous support 27 can also be replaced in this regard by an arrangement of open channels, so that the workpiece 3 is sucked to the openings of the channels.

Another alternative or additional possibility for holding the workpieces 3 is to clamp the workpieces at their edges by means of a clamping ring, which lies flat against the workpiece at least in parts of the substrate circumference, in order to prevent the formation of local stresses that could lead to workpiece fracture. This embodiment is particularly suitable in the case of workpieces 3 in the form of round wafers.

In general, it is advantageous if the holder 9 has an apparatus for centering the workpiece(s) 3 at designated holder positions. This centering should preferably comprise center-to-center centering, i.e. with respect to the x and y directions. For example, the recess 93 could serve as such an apparatus. Centering the workpieces 3 serves, on the one hand, to ensure precise positioning with respect to the machining points 16 to be inserted. Furthermore, imbalance can also be reduced in this way. Alternatively or additionally, an apparatus for balancing the holder 9 can be provided in order to minimize imbalance. Such an apparatus can, as represented, in particular comprise weights 28 attached displaceably to the holder 9.

In particular, it is provided that balancing can take place during processing, which means, in particular, that balancing is possible during rotation. This can be achieved by displacing the weights 28 during the rotation of the rotatable holder 9. This can be achieved by suitable electronic control apparatuses and/or actuators during processing. In this way, defects in the workpiece(s) that arise during processing and lead to an imbalance can be compensated. It is also possible that material from the workpiece is removed from the workpiece during the insertion of the filaments, in particular by ablation. This can also result in imbalances that can be advantageously compensated, in particular by the mechanism described.

In the case of rotational processes, particularly at higher rotational or turning speeds, for example, those of several tens of revolutions per second and more, the mass distribution has a significant influence on the uniformity of rotation of rotatable holder workpieces. Disturbances in the mass distribution can arise, for example, if not all possible workpiece positions are occupied, if the workpieces to be processed are of different types, particularly with regard to material, size, and quality (e.g., thickness variations), if the mass distribution changes as a result of processing and the associated mass loss, both when filament-shaped defects are introduced, but in particular as a result of ablation processes that may be associated with it or occur otherwise, and/or if a workpiece is destroyed during processing due to the prevailing centrifugal forces.

The mass loss during workpiece processing should therefore advantageously be less than 10%, relative to the original mass of an inserted workpiece, particularly advantageously less than 5%, particularly advantageously less than 1%. Generally, or even in the case where the resulting mass loss leads to impaired rotation, an imbalance in the rotation of the system comprising the rotatable holder 9 and workpiece 3 can be reduced or even eliminated, as described, by means of displaceable balancing weights, in particular those of different masses. Such balancing weights 28 can, for example, be integrated into the substructure of the substrate/workpiece carrier, and their radial position and direction can be determined by mechanically adjustable components. In a particularly advantageous embodiment, the position of the balancing weights 28 can be dynamically adjusted and calibrated during rotation.

In the case of the exemplary embodiments of FIGS. 7, 8 and 9, the machining points 16, or the impact points 71 of the laser beam 70, lie on curved, in particular circular paths 17. However, in a further development of the device and the method, it is also possible to compensate for this curvature. For this purpose, in a further development of the invention, the control apparatus 13 is configured to track the impact points 71 of the laser beam 70 in the radial direction by means of the positioning apparatus 5 such that the impact points 71 lie on the workpiece 3 in a row one behind the other on a straight line. This can be achieved in a simple manner according to a further development by a sinusoidal movement of the laser beam 70, in particular of the laser 7, in the radial direction. This movement is synchronized with the angular position of the holder 9. The aim is to avoid, for example, a curvature of the radially spaced sides of a contour, as shown in FIG. 6, by moving the laser relative to the workpiece 3 and instead to create straight segments of successive filament-shaped defects without the need for multiple passes or rotations. An example of this is shown in the diagram in FIG. 12. Here, the radial coordinate r (P) of the impact point is plotted as a function of the rotational angle q. In general, without being restricted to the example, an oscillation of the laser beam 70 in the radial direction synchronized with the rotation or the rotational angle can be controlled by the control apparatus 13 to compensate for and produce machining points 16 lying in a straight line. The example represented applies to four workpieces 3 arranged on the holder 9. Their centers are located at the angular positions 0, π/2, π, 3/2π, and 2π. To generate straight lines of machining points, the laser beam 70 is moved radially outward toward the edges of the workpieces and radially inward again from the edges toward the center.

In the case of the exemplary embodiments described so far, the workpiece is moved on the rotating holder. However, a reverse configuration is also conceivable, in which the laser 7 is rotated with the holder 9 by means of a drive 11. Such a configuration is particularly advantageous in the case of inline machining, among other things.

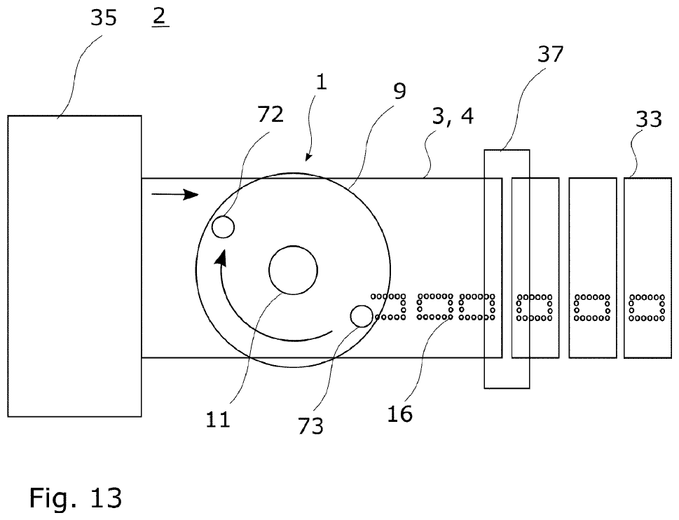

FIG. 13 shows in this regard an example of a hot-forming system 2 with a device 1 for laser machining workpieces. The hot-forming system 2 is configured, by means of a hot-forming device 35, to produce a continuous material strip, in particular a workpiece 3 in the form of a continuous glass strip 4. The glass strip 4 then passes through the device 1 for laser machining, in which at least one laser 72, 73 is arranged on the rotatable holder 9 of the positioning apparatus and is rotated with the rotatable holder 9, so that the rotation changes the position of the laser 72, 73 not only along the feed direction of the glass strip 4, but also transversely thereto, and in this way, various predetermined impact positions of the laser beam are adjusted. In the case of the example represented, the impact positions are adjusted such that the machining points 16 form frame-shaped contours. The glass strip 4 is fed to a separating device 37, with which the glass strip 4 is separated into individual glass plates 33. In the example represented, machining with the device 1 takes place before separation, but can also be carried out on the individual glass plates 33 after separation.

In summary, a hot-forming device 2 is thus provided which is configured to produce a continuous material strip, in particular a continuous glass strip 4, wherein the hot-forming device 2 comprises a device 1 for laser machining workpieces, which device has a rotatable holder on which at least one laser 7, 72, 73 is held in order to move to processing points on the strip or on the plates 33 by rotating the holder during the advance of the material strip or individual plates 33 separated from the strip and to machine them by emitting a laser beam.

The invention offers the advantage of being able to introduce filament-shaped defects into workpieces at higher processing speeds than previously known by using the rotation principle. This allows workpieces to be manufactured more efficiently.

List of reference signs

| | |
|---|---|
| 1 | Device for laser machining workpieces |
| 2 | Hot-forming system |
| 3 | Workpiece |
| 4 | Glass strip |
| 5 | Positioning apparatus |
| 7, 72, 73 | Laser |
| 8 | Focusing optics |
| 9 | Holder |
| 10 | Sensor |
| 11 | Drive |
| 12 | Shaft |
| 13 | Control apparatus |
| 14 | Trigger marking |
| 15 | Filament-shaped defect |
| 16 | Machining point |
| 17 | Curved path |
| 18 | Carriage |
| 19 | Apparatus for rotating 3 with respect to holder 9 |
| 20 | Machined portion of 3 |
| 25 | Vacuum pump |
| 27 | Porous support |
| 28 | Weight |
| 30, 31 | Side surface of 3 |
| 33 | Plate separated from 4 |
| 35 | Hot-forming device |
| 37 | Separating device |
| 51 | Adjustment apparatus in the radial direction |
| 52 | Positioning arm |
| 70 | Laser beam |
| 71 | Impact position of 70 |
| 80 | Lens |
| 90 | Axis of rotation of 9 |
| 91 | Surface of 9 |
| 93 | Recess in 9 |

1-27. (canceled)

28. A device for laser machining workpieces, comprising:
at least one laser that is an ultrashort pulse laser which is suitable for introducing filament-shaped defects into workpieces made of glass;
a positioning apparatus for adjusting various impact positions of a laser beam of the at least one laser on a workpiece, the positioning apparatus comprising a rotatable holder for the workpiece with a drive for setting the holder in rotation, wherein an axis of rotation of the holder is oriented such that it has a component parallel to a direction of irradiation of the laser beam; and
a control apparatus configured to control an emission of the laser beam during rotation of the holder in synchronization with the rotation of the holder and thus to set specific impact positions of the laser beam on the workpiece.

29. The device of claim 28, wherein the positioning apparatus comprises an adjustment apparatus for adjusting the impact positions of the laser beam in a radial direction with respect to the axis of rotation of the holder.

30. The device of claim 29, wherein the adjustment apparatus comprises a positioning arm with which the laser beam can be moved in the radial direction.

31. The device of claim 28, wherein the holder is formed to hold the workpiece eccentrically outside the axis of rotation.

32. The device of claim 28, wherein the at least one laser is configured to emit a burst packet of laser pulses.

33. The device of claim 28, wherein the holder is configured to hold a plurality of workpieces such that a circular path sweeps over the plurality of workpieces at a constant radial distance from the axis of rotation, so that during one rotation of the holder, the plurality of workpieces can be machined with the laser beam at impact positions along this circular path with a radial position of the laser beam being kept constant.

34. The device of claim 28, wherein the holder is assigned increments or the holder is provided with increments, wherein the device is configured to use the increments to determine an angle of rotation.

35. The device of claim 28, wherein the device has at least one of the following features:
an apparatus for rotating the workpiece relative to the holder;
an apparatus of the holder for centering the workpiece at intended holder positions; or
an apparatus for balancing the holder by means of weights displaceably attached to the holder.

36. The device of claim 28, further comprising an optical system which is suitable for introducing filament-shaped defects into the workpiece with a preferred direction in a direction of an intended separating line.

37. A method for laser machining workpieces, the method comprising:
machining a workpiece with a laser beam emitted by an ultrashort pulse laser, the machining comprising introducing filament-shaped defects while the workpiece and the laser rotate relative to one another in order to adjust different impact positions of the laser beam of the laser on the workpiece, wherein the workpiece is held on a rotatable holder of a positioning apparatus, the holder is set in rotation by means of a drive, and the workpiece rotating on the holder is machined with the laser beam;
wherein the laser beam is directed onto the workpiece in such a way that a direction of irradiation of the laser beam has a component parallel to an axis of rotation of the holder; and
wherein the emission of the laser beam and thus the impact position of the laser beam is controlled by a control apparatus during the rotation of the holder and synchronized with the rotation of the holder and thus adjusted.

38. The method of claim 37, wherein the laser beam is moved continuously with a movement component in a radial direction at least temporarily during the rotation of the holder and the workpiece is machined during this movement by irradiation of the laser beam.

39. The method of claim 37, wherein, by means of the control apparatus, a pulse frequency of the laser and/or a rotational speed of the holder is set as a function of a radial distance of a point of impact of the laser beam to the axis of rotation of the holder.

40. The method of claim 37, wherein a rotational speed of the holder is from 5 to 25 revolutions per second.

41. The method of claim 37, wherein a pulse frequency of the laser is from 6 MHz to 30 MHz.

42. The method of claim 37, wherein the laser emits a burst packet of laser pulses.

43. The method of claim 37, having at least one of the following features:
the workpiece is held flat; or
the workpiece is held countersunk relative to a surface of the holder facing the laser beam.

44. The method of claim 37, wherein the machining comprises at least one of the following machining steps:
local removal of a coating on the workpiece;
local heating for melting or generating thermal stresses;
ablation on a surface of the workpiece; or
modification of a material of the workpiece.

45. The method of claim 37, wherein, in order to generate machining points lying in a straight line, an oscillation of the laser beam in a radial direction, synchronized with the rotation, is controlled by the control apparatus.

46. The method of claim 37, wherein filament-shaped defects are introduced into the workpiece with a preferred direction in a direction of an intended separating line.

47. A workpiece made of glass, comprising:
two opposite side surfaces;
a plurality of filament-shaped defects which run transversely to the side surfaces in a volume of the workpiece, wherein the filament-shaped defects are arranged in a row on a plurality of curved paths, a radius of curvature of which increases in a direction along a side surface, such that the paths run concentrically.
